(19) United States
(12) Patent Application Publication
(10) Pub. No.: US 2009/0164594 A1
(43) Pub. Date: Jun. 25, 2009

(54) Instant messaging market interface

(75) Inventors: Wallace C. Turbeville, New York, NY (US); J. Scott Perry, New York, NY (US)

Correspondence Address: PETER D. AUFRICHTIG;MCCARTHY FINGAR LLP, 11 MARTINE AVE 12TH FLOOR, WHITE PLAINS, NY, 10606, US

(73) Assignee: VMAC, LLC

(21) Appl. No.: 12/317,159

(22) Filed: Dec. 19, 2008

Related U.S. Application Data
(60) Provisional application No. 61/014,774, filed on Dec. 19, 2007.

(51) Int. Cl. G06F 15/16

(52) U.S. Cl. 709/206

(57) ABSTRACT

Enabling anonymous negotiations between counterparties via instant messaging protocols, without the need to use client based software, to occur on a fully anonymous basis, through the provision of counterparty credit intermediation and threading of conversations via a masking mechanism. In implementation, the instant message traffic is intermediated by an automated server-based interface which interprets requests for bids or offers and submits such offers to a defined distribution list. The interface then can direct negotiations on an anonymous and automated basis through directed responses and ultimately totally private instant messaging channels.

### CROSS REFERENCE TO RELATED APPLICATIONS

This application claims the priority of provisional application Ser. No. 61/014,774 filed in the United States Patent and Trademark Office on Dec. 19, 2007.

### BACKGROUND OF THE INVENTION

The invention is directed to an instant messaging market interface for a computerized brokerage environment, facilitating direct negotiations with counterparties on a fully anonymous basis. Currently, when a party contacts a broker, his identity is often given up to the marketplace; in addition, if negotiations are direct, they are not anonymous either. Anonymity is important in illiquid markets in order to be able to transact without moving the market prices. Instant messaging is used by over the counter (OTC) trading firms worldwide to negotiate terms of contracts. The two key elements required for OTC Instant Messaging (IM) negotiations are the credit profiles and relative market power of the counterparties. Brokers often utilize IM's to distribute potential transaction data to traders and to communicate with the traders to intermediate the negotiations of a transaction. Brokers generally distribute trading Bids/Offers predicated on the ability of potential parties to bilaterally contract or clear a transaction post trade.

### SUMMARY OF THE INVENTION

An object of the present invention is to create a method and system of enabling negotiations between counterparties via IM protocols, without the need to use client based software.

Another object of the invention is to create a method and system of IM negotiations that occur on a fully anonymous basis.

Yet another object is to provide a system for enabling instant messaging negotiations including a distributed server, computer platform and internet connectivity.

A further object of the present invention is to create a method and system of IM negotiations through the provision of counterparty credit intermediation and threading of conversations via a masking mechanism.

Yet another object of the present invention is to create a method and system of IM negotiations where the IM traffic is intermediated by an automated server-based interface which interprets requests for bids or offers and submits such offers to a defined distribution list.

Another object of the present invention is to create a method and system of IM negotiations where the interface can direct negotiations on an anonymous and automated basis through directed responses and ultimately totally private IM channels.

The invention accordingly comprises the features of construction, combinations of elements and arrangements of parts which will be exemplified in the construction as hereinafter set forth, and the steps in the methods utilized in the process hereinafter set forth and the scope of the invention will be indicated in the Claims.

### BRIEF DESCRIPTION OF THE DRAWINGS

FIG. 1 shows a schematic diagram of the functional components of the invention;

FIG. 2 shows a flow chart of the method of the invention implemented; and

FIG. 3 shows a diagram of the instant messaging system of the invention.

### DETAILED DESCRIPTION OF THE PREFERRED EMBODIMENTS

The invention incorporates a system which enables negotiations between counterparties via IM protocols, without the need to use client based software. The system allows traders to negotiate on a fully anonymous basis, through the provision of counterparty credit intermediation and threading of conversations via an IM masking mechanism. IM traffic is intermediated by an automated server-based interface which can receive IM calls from a plurality of IM networks. The service-based interface will then thread each negotiation in a separate IM conversation address. The invention also interprets requests for bids or offers and submits such offers to a defined distribution list. The interface then can direct negotiations on an anonymous and automated basis through directed responses and ultimately totally private IM channels.

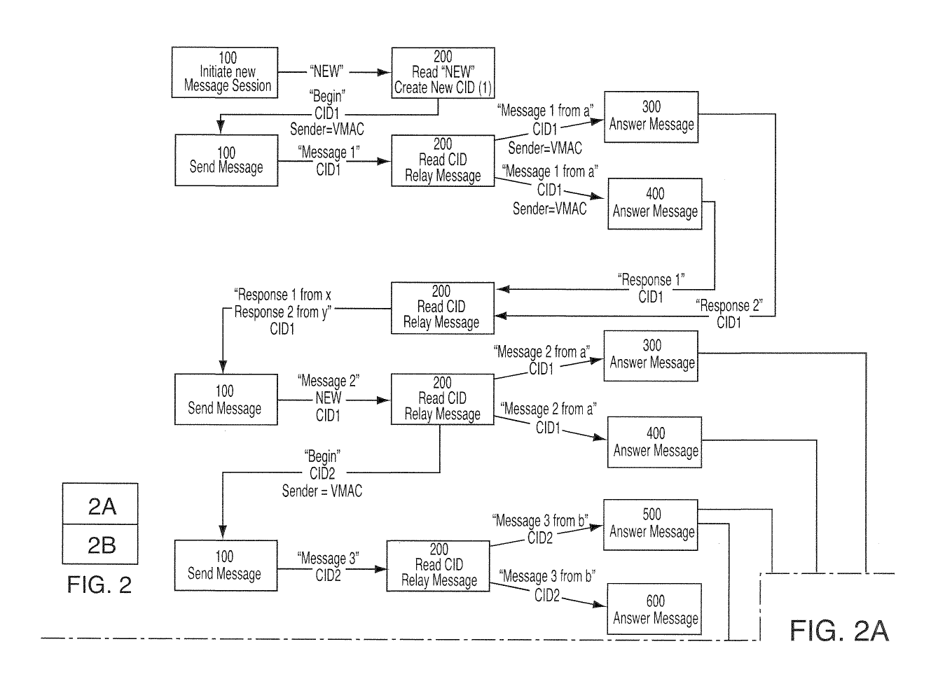

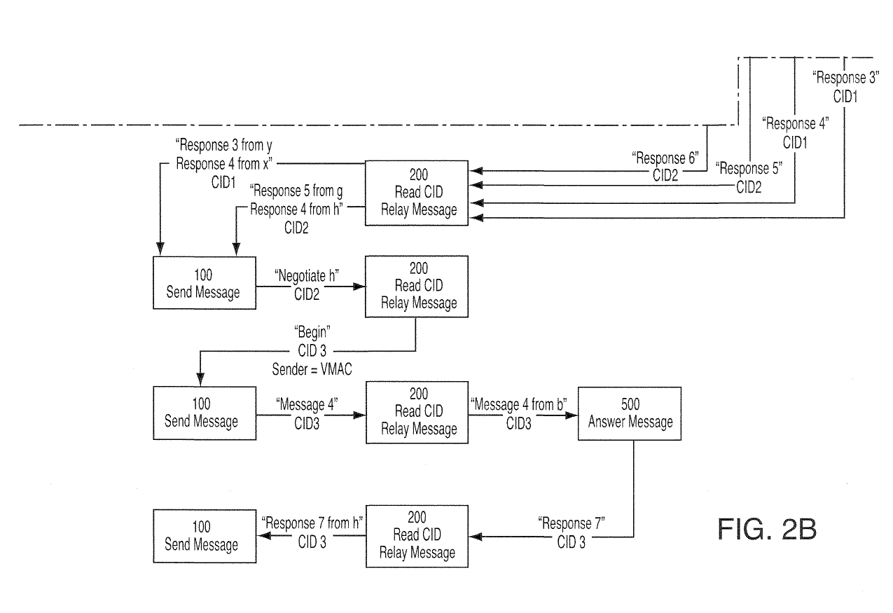

As shown in FIG. 2, Step 100 is where a user (initiator) would start the process by sending a message from a proprietary IM Network (for this example AOL) to a system IM address 200 within the same proprietary IM Network (i.e. AOL, in this example) to initiate a trade. The system address would be a base address which could use a generic name such as “DESK”. In the first step 100, the initiator sends a keyword message, such as NEW. The system interprets this keyword, and performs database functions as follows:

a) assigns a conversation identification (CID) to be used in all further conversations with the initiator and any entities to which the transaction is to be directed; b) assigns session names to each party in the database; these names will be used to track individual entity responses without giving out real names; c) the system would respond back to an AOL IM initiator, for example, with an AOL IM from CID1 with the instruction “Begin”. This lets the initiator know that the system is ready to disseminate the trade information. This is manifested by the IM system opening a new dialogue box on the initiator's computer to handle conversation between CID1 (AOL IM address) and 100.

Next the Initiator 100 sends his market message (message 1) to CID1 (AOL IM ADDRESS); the system then pulls this message and sends it in Steps 300 and 400 to various parties. For example, the user in step 300 could be on the Yahoo IM Network, so the system will send a preselected IM CID1 which it maintains with Yahoo, and forward the message to 300 on the Yahoo IM system.

Step 300 receives a message from CID1 (YAHOO IM). If the user in Step 400 is on AOL, this user will receive the same message from CID1 (AOL IM).

In Steps 300 and 400 when the users respond, they respond directly to CID1 and the control system then attaches to the message the appropriate session names assigned for the negotiation. The initiator 100 then receives a message from CID1 (AOL IM) which contains the two responses, coded by the session names. Initiator 100 could then choose to respond to a single session name.

In this example, the initiator in Step 100 chooses instead to open an new negotiation, i.e. place in the market a new bid/offer product or price spread. The user does this by sending the keyword NEW to the system DESK. The system reads this message and creates a new conversation ID, CID2, and assigns the names “g” at Step 500 and “h” at Step 600. Then CID2 responds back to the initiator. This would manifest in the IM environment by opening a new dialog box to handle discussion between Initiator 100 and CID2.

The user in Step 100 then sends a message to the users of Step 500 and 600, and receives messages back via the control system as described above. He then chooses to negotiate with the response labeled as coming from “h” by sending a keyword message back to CID2 (in this case “Negotiate h”). The control system then creates another new dialog, which will handle only negotiations between users 100 and 600. In the configuration shown here, a new dialog ID will be created to handle the negotiation, CID3.

### Receiving Calls

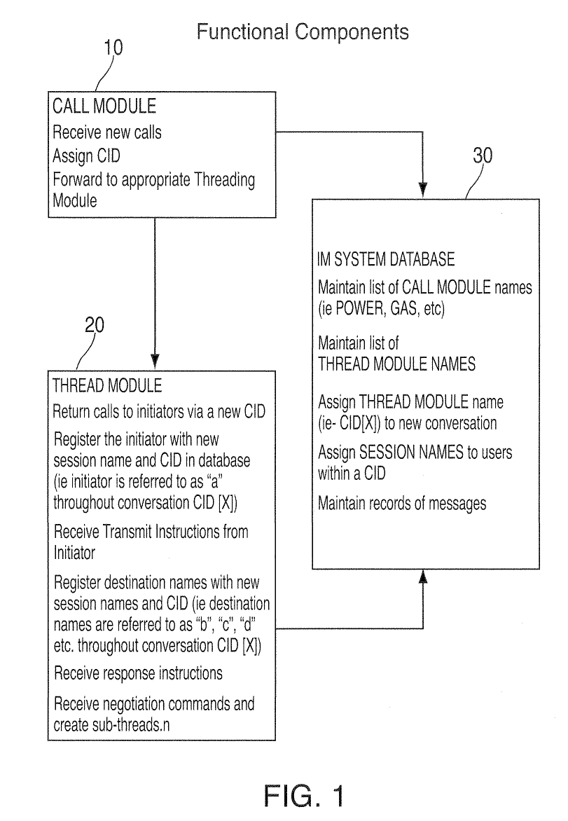

In a preferred embodiment of the invention, a main server module 10 (the Call Module) as seen in FIG. 1 receives IM calls from users via a plurality of proprietary IM networks. The Call Module 10 will maintain several basic “desk names” which are defined by product and tenor of the contracts. As an example the Call Module 10 may have an address related to Natural Gas within 1 year, or PJM Power products, or may have an address of POWER or NATGAS, which would address messages to groups with specific interests in Power or Gas.

The Call Module 10 will maintain a number of “desk name” addresses on multiple networks, but incoming calls will be directed to specific “desk names” within each network. As an example there would be a single “POWER” desk name on the AOL network, and a single “POWER” desk name on the Yahoo network etc.

The Call Module 10 “listens” for new calls requesting the initiation of a negotiation. When a new call is indicated via Command Words, the Call Module 10 replies to the initiator with a CONVERSATION IDENTIFIER (CID) and then initiates procedures which result in the assignment of a specific negotiation thread and “calls back” with a new system address, “CID[X]”. The call back will be within the initiating callers IM network, and will indicate the caller IM address of CID[X] on the call. All further communications with the initiator for this specific transaction will be via the call back address CID[X].

### Establishing Message Threading

In a preferred embodiment, when a call is received by the Call Module 10 “desk name”, the Call Module 10 assigns a specific CID to the requested negotiation, and will hand off the caller to the “Thread Module” 20. Thread Module 20 will then respond to the call via a transaction specific negotiation name CID[X], different from the “desk name”. This negotiation name will be assigned to handle all IM traffic related to the originating call. Any information transferred by the originating caller will be passed to other users via this same Negotiation Name across a plurality of IM networks.

### Message Masking

The instant messaging marketing interface system includes a server based system 30 (the System) which is accessed via internet IM protocols. The System 30 can respond to any network IM's as long as the System maintains “desk names” (such as POWER, GAS etc) and “Negotiation Names” (such as CID1, CID2, CID3 etc) on the IM network. The Thread Module 20 tracks, interprets and redirects IM messages both within and between IM networks (such as AOL, GMAIL, Yahoo, etc.). Once a negotiation is initiated by the Call Module 10, the Thread Module 20 captures IM messages from a sender, and disseminates them to a distribution list, which can be predetermined or of the initiator's choosing. When the message is sent by the Thread Module 20 to a recipient's IM address, the originating sender's IM ID is masked through a uniform protocol, and the receiving IM user sees only the negotiation name, CID[X] IM Address assigned by the Thread Module 20.

### Command Words

The Call Module 10 and Thread Module 20 will each recognize certain command words if encountered as text embedded in messages. For example, a trader may wish to initiate a new negotiation by calling the Call Module 10. This initiator might send the message “NEW” to the Call Module 10. The Call Module 10 then will react by calling the Thread Module 20 to create a new conversational negotiation name, CID[X]. The trader would then receive a return IM message from the negotiation name, CID[X]. All further communications regarding the specific negotiation would then be with this VMAC negotiation name and would appear in a separate conversation IM box on the user's computer. Other command words could relate to transacting such as BUY or SELL or DONE, and would call procedures within the conversation with the negotiation name IM address via the Thread Module 20.

Other keyword actions would include “SYSTEM” or “CLEAR”. When the Thread Module 20 receives this command, it would then direct certain message information to a control system trade submission process or clearinghouse process. In this way the commercial elements of assuming the credit worthiness of the proposed counterparty are determined without breaking the anonymity.

### Sub-Groups

As described above, the Thread Module 20 will recognize certain key words, and react accordingly. Specific commands can include selections of specific distribution lists, and the command word would be “DISTLIST”. Text following this command would then be utilized by the THREAD to either implement a list which would follow the text DISTLIST and end in END; or the command DISTLIST could be followed by a number, which would select a prearranged list residing at the Module server for specific senders.

### Responding to SYSTEM IM Messages

The Thread Module 20 will forward messages from an initiator to a predetermined list of recipients across a plurality of IM networks. These recipients will see the initiator's bid/offer information in an IM message sent by the system CID[X] IM address. Responses to this bid/offer will be to the system address CID[X], and will then be forwarded by the Thread Module 20 back to the initiator. The communication between the user and the system's Thread Module and between the system's Thread Module and other participants are internet based.

### Multiple Send Out; Aggregated Responses

When receivers of a message respond to the ‘negotiation name’, their response are also masked, so that the original sender can see all responses, but with only the Thread Module 20 IM address (i.e. the negotiation name, CID[X]) associated with the responses. Further, if the initial message is sent out to various parties and multiple parties respond, the multiple responses are returned to the original user under the same conversation thread anonymously.

### Threading Logic

### Beginning New Conversation

As seen in FIG. 2, an IM user can initiate a new conversation in Step 100 anonymously with other users by contacting the specific system “desk name” and using the Module Commands (see Command Words above). This can be a word or phrase predetermined by the operator of the Call Module 10, such as “NEW”. When the Call Module 10 receives an incoming IM message with this word in a predetermined position (i.e. as the first characters, in quotes, as the sole message content etc), it will assign a new “Conversation ID” (CID) for the Thread Module 20 to use for all communications with the sender related to the initiated message, and immediately hand off the IM call to the Thread Module 20. The Thread Module 20 will then call the sender back from the sub-name assigned (i.e. the negotiation name). This creates a conversational “Box” which will house all further related conversations.

### Sending Out the Message; Responses to Message

Once the CID is created and established with sender, the Thread Module 20 forwards bid/offer information from the initiator to recipients from a negotiation name, tagged to the message with the same CID assigned to the sender's initiated message. Any user responses to the Thread Module 20 by the recipients will be also be tagged with the same CID, and therefore be contained in the same conversational “Box”. When multiple recipients respond to a message, their responses will show up in the same conversation thread to the single initiator, because they all will be responding via the same CID; however, the Module will assign each party a Session Name (“a”, “b”, etc) for the duration of the conversation so that the message sender can parse which responses are from separate entities.

### Sub-Threading

The Thread Module 20 will also recognize certain command words which will allow user to drill down to a private, yet anonymous conversation. By typing a word such as “Negotiate” followed by the session name of the responder with which negotiations are to be pursued, a new private CID[X] thread “Box” is opened for the parties to finish their dialogue, which can be marked “sub conversation n of x” to relate it back to original conversation x.

### Completion of Negotiation

Upon acceptance of terms by a responder to a bid/offer, the responder will send a message “DONE” to the Thread Module 20. This will trigger processes within the Thread Module to call third party systems (such as the VMAC contract control system offered by VMAC LLC) and initiate the creation of a contract and confirmation. A message will then be sent to the initiator confirming the completion and execution of the transaction.

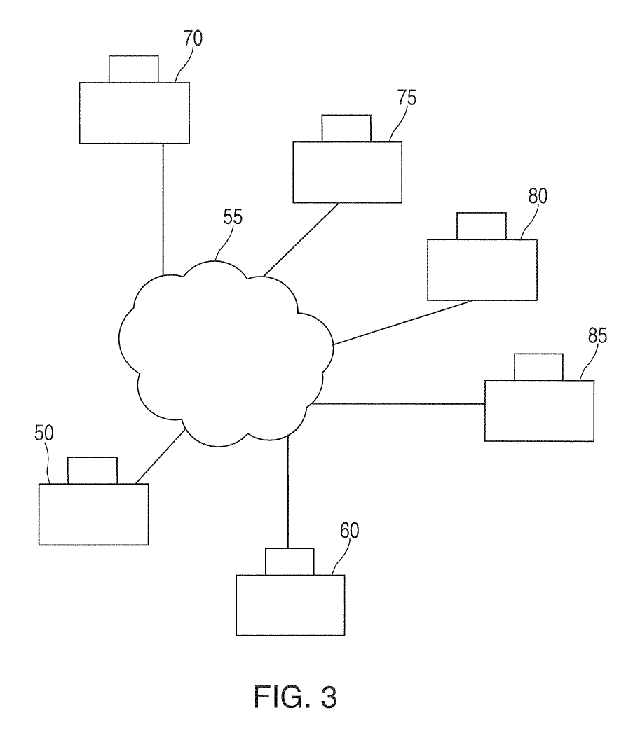

FIG. 3 shows a diagram of the system apparatus according to the present invention. The initiator's computer 50 is where the initiating user types a first instant message that is sent through the internet 55. The instant message is then received by the system server 60 which then sends out instant messages to other users 70, 75, 80 and 85 through the internet 55. Similarly responses from users 70, 75, 80 and 85 for user 50 go to the system's server 60 via the internet 55 and are then redirected by the system's server 60 through the internet to user 50.

It will thus be seen that the objects set forth above, among those made apparent in the preceding description, are efficiently obtained and, since certain changes may be made in the above constructions without departing from the spirit and scope of the invention, it is intended that all matter contained in the above description or shown in the accompanying drawings shall be interpreted as illustrative, and not in a limiting sense.

It is also to be understood that the following claims are intended to cover all of the generic and specific features of the invention, herein described and all statements of the scope of the invention which, as a matter of language, might be said to fall there between.

What is claimed is:

1. An anonymous instant messaging negotiating system for multiple users and products comprising:
A plurality of instant messaging devices, each user having a separate instant messaging device;
A control server, coupled to the plurality of instant messaging devices through the internet, the control server including a command means, call module, thread module and masking means;
the command means coordinating the activities of the control server and acting on messages received from users, coupled through the internet to the plurality of instant messaging devices;
the call module, coupled to the command means for receiving commands received by the command means from one or more of the plurality of instant messaging devices through the internet to direct an instant message anonymously to the thread module which assigns a thread identification and then notifies all appropriate users of the contents of the instant message;
the thread module, coupled to the command means and the call module, assigns a conversation ID for each separate negotiable trade and sends the conversation ID to each appropriate user's instant messaging device over the internet for the users to reply and participate in a negotiation; and
the masking means, coupled to the command means, for assigning session names to each of the users to maintain anonymity of the users during the instant messaging based trade negotiations;
whereby an instant messaging based negotiation system is implemented which allows for negotiation of trades with anonymity of the participants.

2. A method of negotiating trades by anonymous instant messaging between multiple users and for a variety of products and contracts, comprising:
Initiating an instant message conversation by an instant messaging device sending the instant message to a control system through the internet to begin the negotiations;
assigning a conversation identifier in the control system and a thread module to the instant message based on the product and contract to be negotiated;
identifying the appropriate users to be notified of the product and contract to be negotiated;
assigning session names to each appropriate user to maintain their anonymity;
notifying the appropriate users through the instant message protocol that they are using of all product and contract negotiations appropriate to each user;
controlling an anonymous instant message negotiation either between a single initiating party and multiple potential counterparties or the initiating party and a single negotiating counterparty through a thread module connecting through the internet to each of the users;
whereby anonymous instant message negotiation of trades is achieved.

3. The method of claim 2 wherein the instant messages are received and transmitted using at least two different instant messaging platforms.

4. The method of claim 2 further including intermediating the credit of the negotiating users to assure that the initiating user and any negotiating user is credit qualified to complete the contemplated trade prior to allowing the users to negotiate a trade.

5. The method of claim 2 further comprising sending the data from the instant message negotiation to a control system upon completion for confirmation and establishing a formal contract.

6. The method of claim 2 further including creating a distribution list of specific users to contact as appropriate users.
